(19) United States
(12) Patent Application Publication
(10) Pub. No.: US 2011/0030277 A1
(43) Pub. Date: Feb. 10, 2011

(54) WINDOW ASSEMBLY FOR VEHICLE

(75) Inventor: Gary DeGroff, Holland, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA MIRRORS OF AMERICA, INC., Holland, MI (US)

(21) Appl. No.: 12/850,871

(22) Filed: Aug. 5, 2010

Related U.S. Application Data
(60) Provisional application No. 61/232,250, filed on Aug. 7, 2009.

(51) Int. Cl. E05D 15/16; E06B 7/16

(52) U.S. Cl. 49/128

(57) ABSTRACT

A window assembly for a vehicle includes a frame configured to mount to a transit vehicle, a fixed window panel affixed to a portion of the frame, and a movable window assembly having a movable window panel circumscribed by a movable frame. The movable frame has opposite end members and a pair of opposite slide rail members. The slide rail members are slidably received in respective channels along opposite portions of the frame. Each of the slide rail members includes a co-extruded slide rail having a semi-rigid or rigid rail portion, a flexible window seal co-extruded with the rail portion for sealing against the movable window panel, and a flexible sliding seal co-extruded with the rail portion for slidably engaging the opposite portions of the frame when the movable window assembly is assembled to the frame and is moved between its opened and closed positions.

### CROSS REFERENCE TO RELATED APPLICATION

The present application claims the priority benefit of U.S. provisional application Ser. No. 61/232,250, filed Aug. 7, 2009, which is hereby incorporated herein by reference in its entirety.

### FIELD OF THE INVENTION

The present invention relates to windows for vehicles and, more particularly, to window assemblies including window panels and frames for school buses or transit vehicles or the like.

### BACKGROUND OF THE INVENTION

Vehicle window assemblies, such as for school buses and the like, typically include a frame that includes four aluminum side frame portions that are screwed or fastened together at the corners of the frame. The window panels, typically one fixed window panel and one movable window panel, are retained within channels along the frame portions while the frame portions are fastened together to form the window assembly. The assembly of such window assemblies typically requires multiple components and is typically labor intensive.

### SUMMARY OF THE INVENTION

The present invention provides a window assembly or window module or window unit for a vehicle, such as a transit vehicle or school bus, that includes a frame and a fixed window panel at least partially encapsulated or surrounded by the frame and a movable window assembly that includes a movable window panel encapsulated by a movable frame portion and that is movable relative to the frame and the fixed window panel between opened and closed positions. The frame includes opposite side frame portions that receive respective side perimeter edge regions of the fixed window panel and that have a channel that slidably receives a co-extruded unitarily formed side slide rail of the movable frame portion of the movable window panel assembly.

The slide rail of the movable window panel assembly comprises a co-extruded rail that has a hard or rigid or semi-rigid plastic rail portion that is formed to be received in the channel of the side frame portion and that is formed to receive a side perimeter edge region of the movable window panel in a channel formed in the rail portion. The slide rail has a flexible window seal co-extruded in and along the channel of the rail portion for engaging and sealing against the movable window panel when the perimeter edge region of the movable window panel is at least partially received in the channel of the rail portion. A flexible rail seal is also co-extruded at the outer portions of the rail portion for sealing against and slidably engaging the channel formed in the side frame portion of the window frame when the slide rail is received in the channel of the fixed side frame portion. Optionally, a slip coat material may be co-extruded over at least a portion of the flexible rail seal to enhance sliding of the flexible rail seal along the channel of the side frame portion as the movable window panel is moved between its opened and closed positions.

Thus, the slide rail of the present invention comprises a single component that has different materials and elements co-extruded or tri-extruded to form a unitary slide rail member or element. The slide rail and movable window panel assembly of the present invention thus provides a single unitary slide rail and thus substantially reduces the number of components of the slide rail and thus reduces assembly processes in assembling the movable window panel assembly and the vehicle window assembly.

These and other objects, advantages, purposes and features of the present invention will become apparent upon review of the following specification in conjunction with the drawings.

### BRIEF DESCRIPTION OF THE DRAWINGS

FIG. 1 is a perspective view of a school bus incorporating a plurality of window assemblies in accordance with the present invention;

FIG. 2 is a plan view of a window assembly having a movable window with a tri-extruded vertical slide rail in accordance with the present invention;

FIG. 2A is a sectional view of an upper cross rail of the movable window, taken along the line A-A in FIG. 2;

FIG. 2B is a sectional view of a lower cross rail of the movable window, taken along the line B-B in FIG. 2;

FIG. 2C is a sectional view of the tri-extruded vertical slide rail of the movable window, taken along the line C-C in FIG. 2;

FIG. 3 is an enlarged sectional view of the tri-extruded vertical slide rail of FIG. 2C;

FIG. 4 is a plan view of a window assembly having a multi-component frame;

FIG. 4A is a sectional view of an upper cross rail of a movable window of the window assembly, taken along the line A-A in FIG. 4;

FIG. 4B is a sectional view of a lower cross rail of the movable window of the window assembly, taken along the line B-B in FIG. 4; and

FIG. 4C is a sectional view of a vertical rail assembly of the movable window of the window assembly, taken along the line C-C in FIG. 4.

### DESCRIPTION OF THE PREFERRED EMBODIMENTS

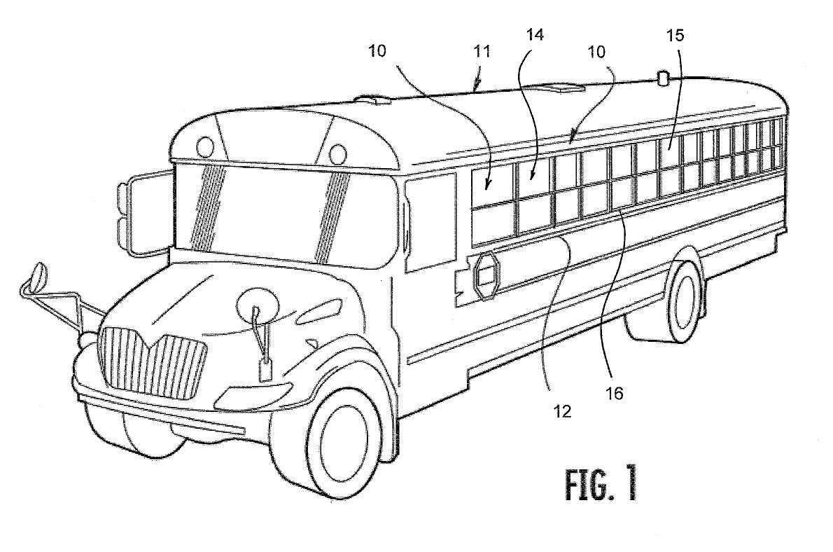

Referring now to the drawings and the illustrative embodiments depicted therein, a window assembly or window module or window unit 10 may be mounted at an opening of a transit vehicle, such as a school bus 11 or the like (FIG. 1). Window assembly 10 comprises a modular window assembly that includes a fixed window pane or panel 12 fixedly attached to a perimeter frame 16, and a movable or slidable window assembly 14 that includes and supports a movable window pane or panel 15 and that slides or moves along perimeter frame 16, and that moves generally vertically relative to the fixed window panel 12 to open and close the window assembly. As shown in FIG. 1, a plurality of window assemblies or modules 10 may be installed along the side of the school bus. The window assemblies may be closely spaced next to one another and may provide a substantially continuous, flush row of window panels along the sides of the school bus. The fixed window panel and movable window panel may comprise any suitable material, such as glass or polycarbonate panels or substrates or the like, without affecting the scope of the present invention.

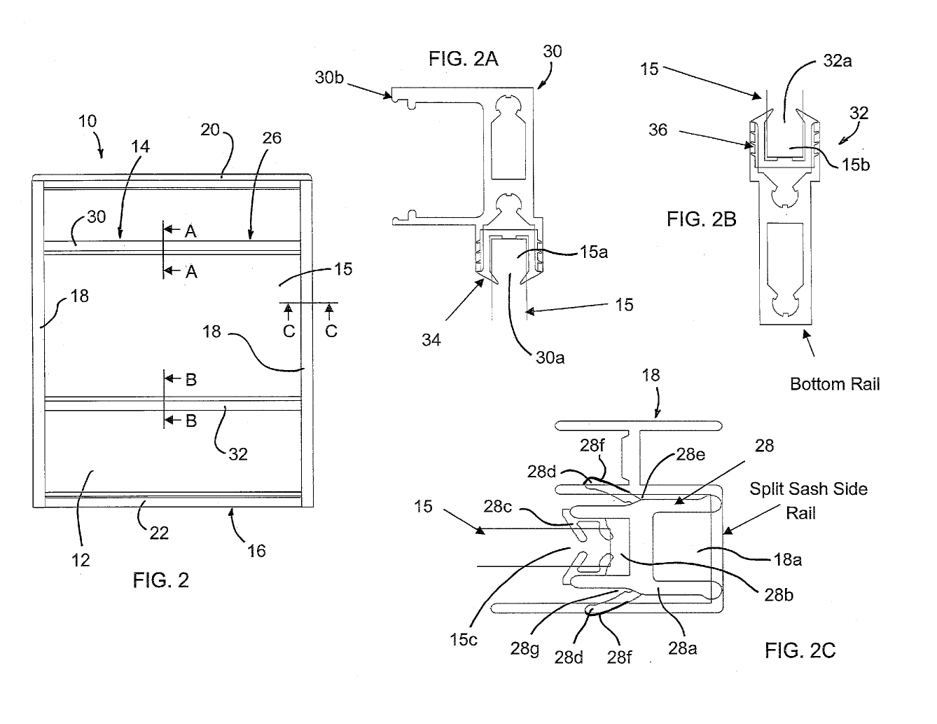

As shown in FIG. 2, perimeter frame 16 includes a pair of generally vertical channel members or side frame members or split sash side rails 18 and a generally horizontal upper channel or frame member 20 and a generally horizontal lower channel or frame member 22. The frame members may be formed of any suitable material, and may be molded or extruded to the desired form (if each member is extruded, the ends of adjacent members may be joined together, such as via ultrasonic welding or bonding or the like). For example, the perimeter frame may comprise a substantially rigid material, such as a substantially rigid polymeric or plastic material, such as glass filled nylon, PVC, polyethylene terephthalate (PET), polypropylene, nylon, acrylonitrile-butadeine-styrene (ABS) or thermoplastic urethane (TPU) or the like. The perimeter frame may also or otherwise comprise, for example, a metallic material or a composite material, such as a filled polymeric or a metal member that is encapsulated in plastic or the like. The frame members may slidably or movably support the movable window unit or assembly 14. Optionally, the window assembly 10 may utilize aspects of the window assemblies described in U.S. Pat. No. 7,427,096, which is hereby incorporated herein by reference in its entirety.

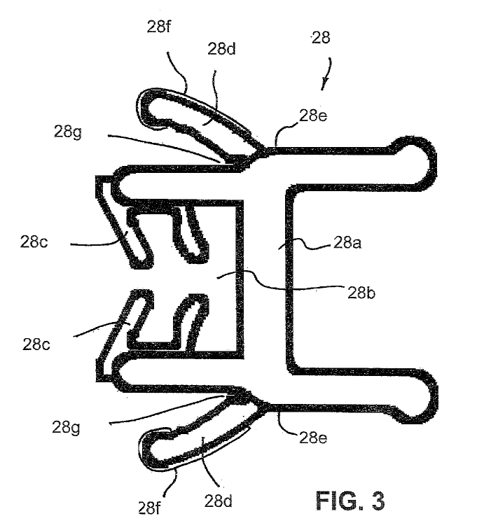

Although shown and described as having a vertically movable window that is movable relative to a single fixed window panel, it is envisioned that aspects of the present invention may be suitable for use in other types of window assemblies having movable windows, such as horizontally movable windows or other vertically movable windows such as those described in U.S. Pat. No. 7,427,096, which is hereby incorporated herein by reference in its entirety. In the illustrated embodiment, movable window or window assembly 14 includes a glass or plastic window panel 15 that is surrounded or encompassed or encapsulated by a movable frame 26. Movable frame 26 includes a pair of generally vertical side slide rails or frame members 28 (FIGS. 2C and 3) and a generally horizontal upper channel or frame member 30 and a generally horizontal lower channel or frame member 32.

As shown in FIG. 2A, upper frame member 30 has a channel 30a along its lower edge for receiving the upper perimeter edge 15a of movable glass window panel 15, and includes a seal 34 disposed within the channel 30a and at least partially around and against the upper perimeter edge of the movable window panel to seal the window panel relative to the upper frame member. Similarly, lower frame member 32 (FIG. 2B) has a channel 32a along its upper edge for receiving the lower perimeter edge 15b of movable window panel 15, and includes a seal 36 disposed within the channel and at least partially around and against the lower perimeter edge of the movable window panel to seal the window panel relative to the lower frame member. As shown in FIG. 2A, the upper frame member 30 may include a latch rail 30b for receiving a latching element for selectively locking and releasing the movable window 14 at selected positions along the fixed window frame between its fully opened and fully closed positions. The lower and upper frame members may be attached to the lower and upper ends of the side slide rails, such as via fasteners or the like, to encapsulate the movable window panel 15 within the movable frame 26.

The side slide rails 28 of movable window 14 are slidably received in the side frame members 18 of the window frame 16, and comprise unitarily formed or co-extruded slide rails. As shown in FIGS. 2C and 3, side slide rail 28 comprises a hard or rigid or semi-rigid plastic rail portion 28a that is formed to be received in the channel 18a of the side frame portion 18 and that is formed to receive a side perimeter edge region 15c of the movable window panel 15 in a channel 28b formed in the rail portion 28a. The slide rail 28 has a flexible window seal 28c co-extruded in the channel 28b of the rail portion 28a (such as along the inner or opposed surfaces of the legs of the rail portion that form the generally U-shaped channel 28b) for engaging and sealing against the side perimeter edge region 15c of the movable window panel 15 when the perimeter edge region 15c of the movable window panel 15 is received in the channel 28a of the rail portion 28. A flexible rail seal 28d is also co-extruded at the outer portions or surfaces 28e of the rail portion 28a for sealing against and slidably engaging the channel 18a formed in the side frame portion 18 of the window frame 16. A slip coat material 28f may be disposed at and/or co-extruded over at least a portion of the flexible rail seal 28d to enhance sliding of the flexible rail seal 28d along the channel 18a of the side frame portion 18 as the movable window 14 is moved between its opened and closed positions. Optionally, and as shown in FIGS. 2C and 3, the flexible rail seals 28d may be formed with a narrowed section or portion 28g to enhance flexing of the flexible seal as the slide rail is received in or inserted in the channel 18a of the side frame portion 18.

Thus, the present invention provides for a co-extruded or tri-extruded slide rail for a movable window unit or assembly, such as for a vehicle, such as for a school bus or other bus or transit or public transit vehicle. The rail portion 28a may be extruded or formed of a substantially rigid polymeric material or plastic material, such as, for example, a glass filled polypropylene material or a calcium carbonate filled polypropylene material (such as a 40 percent calcium carbonate filled polypropylene material or the like). The flexible window seals 28c and flexible rail seals 28d are co-extruded along the rail portion and may comprise the same material as one another, such as a softer or resilient sealing material, such as a rubber or elastomeric or thermoplastic vinyl (TPV) material (such as a material preferably having less than a 80 Shore A durometer, preferably less than 60 Shore A durometer). Optionally, the flexible window seals and flexible rail seals may comprise any suitable material, such as, for example, a polypropylene material (PPE) or EPDM material, and/or may utilize aspects of the seals and seal materials described in U.S. Pat. Nos. 6,220,650; 6,299,235; 6,394,529; 6,572,176; and 6,729,674, which are hereby incorporated herein by reference in their entireties. The slip coat 28f is co-extruded over at least a portion of the flexible rail seal 28d and may comprise a thin layer of a slick or low coefficient of friction material, such as a TEFLON® type material or the like. The coated flexible rail seals 28d thus may readily slide along the channel 18a of the side frame portions and may function to maintain the slide rail 28 generally centered within the channel 18a as the movable window 14 is moved between its opened and closed positions and/or locked or retained at any given position therebetween.

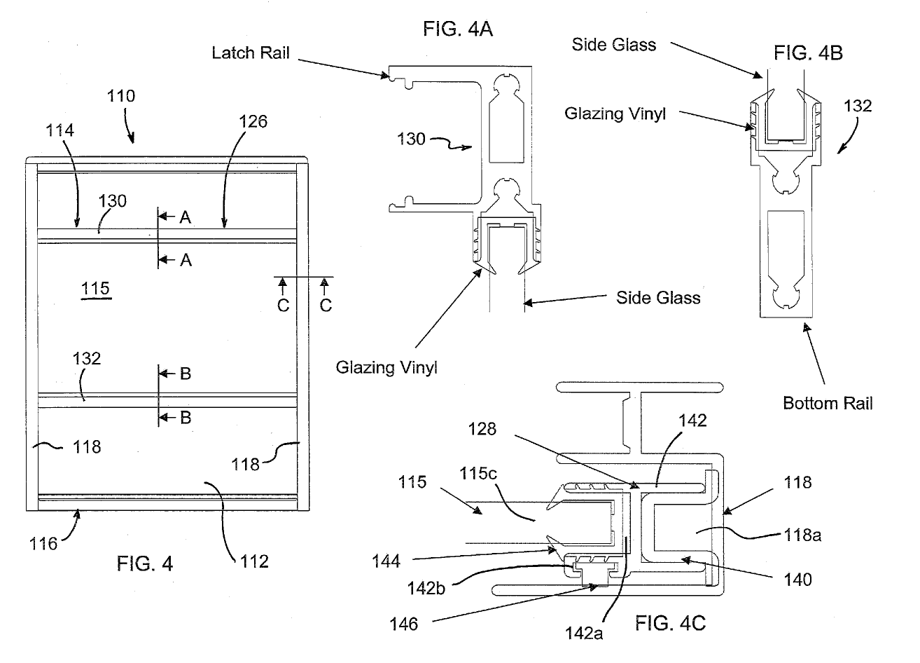

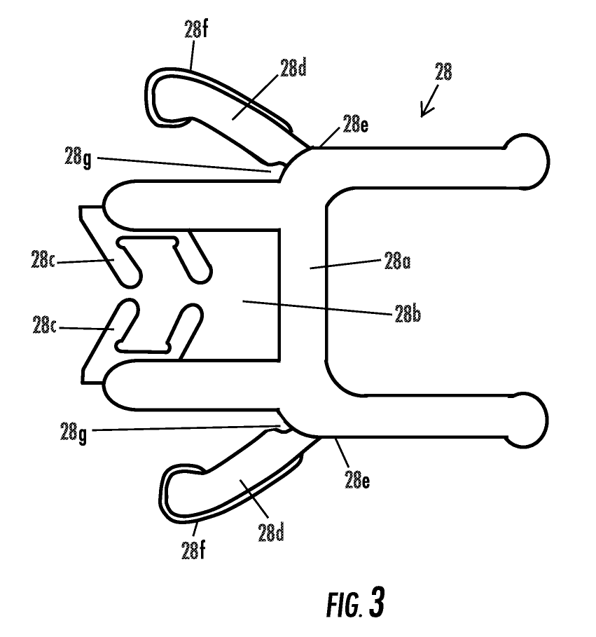

Thus, the present invention provides for a substantial reduction in the number of parts typically required or utilized in a side slide rail for a movable window assembly. For example, and with reference to FIGS. 4 and 4A-C, a typical school bus window assembly 110 may include a fixed window pane or panel 112 fixedly attached to a perimeter frame 116, and a movable or slidable window assembly 114 that includes and supports a movable window pane or panel 115 and that slides or moves along perimeter frame 116, and that moves generally vertically relative to the fixed window panel 112 to open and close the window assembly, such as in a similar manner as movable window 14, discussed above. Like movable window 14, discussed above, movable window 114 includes a glass or plastic window panel 115 that is surrounded or encompassed or encapsulated by a movable frame 126. Movable frame 126 includes a pair of generally vertical side slide rails or frame members 128 and a generally horizontal upper channel or frame member 130 and a generally horizontal lower channel or frame member 132. As can be seen in FIGS. 4A and 4B, upper and lower frame members 130, 132 may be substantially similar to upper and lower frame members 30, 32, discussed above, such that a detailed discussion of these frame members need not be repeated herein.

As shown in FIG. 4C, side rail or frame member 128 of known movable window 114 comprises multiple components that need to be assembled together before the movable window frame can be assembled about the perimeter of the movable window panel. In the illustrated embodiment, side rail 128 includes a plastic guide 140 that is received in and retained in the channel 118a of the side frame 118 and an aluminum base portion 142 that is attached to or that receives guide portion so as to be disposed within the channel 118a. Base portion 142 is a generally H-shaped element that receives guide portion 140 at one end and the perimeter edge 115c of the movable window panel 115 at its other end. A separate window seal 144 is disposed within and adhered within the channel 142a of base portion 142 to seal against the perimeter edge 115c of movable window panel 115. A separate weather strip or seal 146 is disposed within and adhered within a channel 142b formed along an outside surface of the base portion 142 to seal the base portion relative to the fixed side frame 118. Thus, a typical slide rail for a typical movable window assembly has four distinct components (the plastic guide, the metal base, the elastomeric or rubber window seal and the weather strip), and each part may comprise a different material. Thus, not only are the components costly as compared to the unitary slide rail of the present invention, but such conventional slide rails are labor intensive to assemble, and typically require adhesive and/or fasteners to adhere or bond or attach the different components together.

Therefore, the present invention provides a window assembly or multiple window assemblies for installation at or attachment to the sides of a vehicle, such as a school bus or the like. The window assemblies are modular window assemblies that may be readily attached to the school bus. The side slide rail of the movable window assembly comprises a unitary construction that is co-extruded or tri-extruded out of three different types of materials. The tri-extruded slide rail thus has no separate parts and thus requires no assembly. The tri-extruded slide rails thus may be readily attached or fastened to the upper and lower frame members to encapsulate the movable window panel, whereby the movable window assembly may be installed at the fixed window frame and the window assembly may be mounted to the side of a vehicle or school bus.

Changes and modifications to the specifically described embodiments may be carried out without departing from the principles of the present invention, which is intended to be limited only by the scope of the appended claims as interpreted according to the principles of patent law.

1. A window assembly for a vehicle, said window assembly comprising:
a frame configured to mount to a vehicle;
a fixed window panel affixed to a portion of said frame;
a movable window assembly comprising a movable window panel circumscribed by a movable frame, said movable frame having opposite end frame members and a pair of slide rail members, wherein said movable window assembly is movable relative to said fixed window panel and said frame between an opened position and a closed position;
wherein said slide rail members are slidably received in respective channels along opposite portions of said frame; and
wherein each of said slide rail members comprises a co-extruded slide rail comprising a semi-rigid or rigid rail portion, a flexible window seal co-extruded with said rail portion for sealing against said movable window panel and a flexible sliding seal co-extruded with said rail portion for slidably engaging said opposite portions of said frame when said movable window assembly is assembled to said frame and is moved between its opened and closed positions.

2. The window assembly of claim 1, wherein each of said slide rail members further comprises a slip coat layer co-extruded on at least a portion of said sliding seal.

3. The window assembly of claim 2, wherein said sliding seal comprises a resilient sealing material and wherein said slip coat layer comprises a thin layer of a material having a reduced coefficient of friction relative to said sealing material.

4. The window assembly of claim 3, wherein said slip coat layer comprises a thin layer of a TEFLON® type material.

5. The window assembly of claim 1, wherein said sliding seal and said window seal comprise at least one of a rubber material, an elastomeric material, a thermoplastic vinyl material, a polypropylene material, an EPDM material a material having a hardness of less than a 80 Shore A durometer and a material having a hardness of less than 60 Shore A durometer.

6. The window assembly of claim 1, wherein said rail portion is received in a generally U-shaped channel of said frame and wherein said flexible sliding seal is co-extruded along opposite side portions of said rail portion for engaging opposite walls of said generally U-shaped channel of said frame.

7. The window assembly of claim 6, wherein said rail portion comprises a generally U-shaped window receiving portion for receiving an edge region of said movable window therein and wherein said flexible window seal is co-extruded along inner wall portions of said window receiving portion for engaging and sealing against said movable window panel.

8. The window assembly of claim 7, wherein said sliding seal is co-extruded along outer wall portions of said window receiving portion and extends outwardly therefrom for slidably engaging said opposite portions of said frame when said movable window assembly is assembled to said frame and is moved between its opened and closed positions.

9. The window assembly of claim 1, wherein said movable window assembly is vertically movable relative to said frame and fixed window panel when said window assembly is mounted to the vehicle, and wherein said opposite end frame members comprise upper and lower frame members and said pair of slide rail members comprise side slide rail members.

10. The window assembly of claim 1, wherein said window assembly is configured to mount at a side of a bus.

11. A window assembly for a vehicle, said window assembly comprising:
a frame configured to mount to a vehicle;
a fixed window panel affixed to a portion of said frame;
a movable window assembly comprising a movable window panel circumscribed by a movable frame, said movable frame having opposite end frame members, and a pair of slide rail members, wherein said movable window assembly is movable relative to said fixed window panel between an opened position and a closed position;
wherein said slide rail members are slidably received in respective channels along opposite portions of said frame; and
wherein each of said slide rail members comprises a co-extruded slide rail comprising (a) a semi-rigid or rigid rail portion that is at least partially received in a generally U-shaped channel of said frame, (b) a flexible window seal co-extruded with said rail portion and along a generally U-shaped channel of said slide rail for sealing against a portion of said movable window panel that is received in said generally U-shaped channel of said slide rail, and (c) a flexible sliding seal co-extruded with and along a portion of said rail portion for slidably engaging said rail portion of said frame when said movable window assembly is assembled to said frame and is moved between its opened and closed positions.

12. The window assembly of claim 11, wherein each of said slide rail members further comprises a slip coat layer co-extruded on at least a portion of said sliding seal.

13. The window assembly of claim 12, wherein said sliding seal comprises a resilient sealing material and wherein said slip coat layer comprises a thin layer of a material having a reduced coefficient of friction relative to said sealing material.

14. The window assembly of claim 11, wherein said flexible sliding seal is co-extruded along opposite side portions of said generally U-shaped channel of said rail portion for engaging opposite walls of said generally U-shaped channel of said frame.

15. The window assembly of claim 11, wherein said window assembly is configured to mount at a side of a bus.

16. A window assembly for a vehicle, said window assembly comprising:
a frame configured to mount to a vehicle;
a fixed window panel affixed to a portion of said frame;
a movable window assembly comprising a movable window panel circumscribed by a movable frame, said movable frame having opposite end frame members, and a pair of slide rail members, wherein said movable window assembly is movable relative to said fixed window panel between an opened position and a closed position;
wherein said slide rail members are slidably received in respective generally U-shaped channels along opposite portions of said frame;
wherein each of said slide rail members comprises a co-extruded slide rail comprising (a) a semi-rigid or rigid rail portion configured to be at least partially received in said generally U-shaped channel of said frame, wherein said rail portion comprises a generally U-shaped channel for receiving a portion of said movable window therein, (b) a flexible window seal co-extruded with and along inner wall portions of said generally U-shaped channel of said rail portion for sealing against said portion of said movable window panel received therein, and (c) a flexible sliding seal co-extruded with and along another portion of said rail portion for engaging a portion of said generally U-shaped channel of said frame; and
wherein each of said slide rail members comprises a slip coat layer at least a portion of said sliding seal for slidably engaging said generally U-shaped channel of said frame when said movable window assembly is assembled to said frame and is moved between its opened and closed positions.

17. The window assembly of claim 16, wherein said sliding seal comprises a resilient sealing material and wherein said slip coat layer comprises a thin layer of a material having a reduced coefficient of friction relative to said sealing material.

18. The window assembly of claim 16, wherein said slip coat layer is co-extruded along said at least a portion of said sliding seal.

19. The window assembly of claim 16, wherein said flexible sliding seal is co-extruded with and along at least one wall of said generally U-shaped channel of said rail portion for engaging at least one portion of said generally U-shaped channel of said frame.

20. The window assembly of claim 16, wherein said flexible sliding seal is co-extruded with and along opposite walls of said generally U-shaped channel of said rail portion for engaging opposite wall portions of said generally U-shaped channel of said frame.
